(19) United States
(12) Patent Application Publication
(10) Pub. No.: US 2011/0238927 A1
(43) Pub. Date: Sep. 29, 2011

(54) CONTENTS DISTRIBUTION DEVICE , CONTENTS DISTRIBUTION CONTROL METHOD, CONTENTS DISTRIBUTION CONTROL PROGRAM AND CACHE CONTROL DEVICE

(76) Inventor: Hiroyuki Hatano, Tokyo (JP)

(21) Appl. No.: 12/998,696

(22) PCT Filed: Nov. 18, 2009
(86) PCT No.: PCT/JP2009/069558

§ 371 Date: May 20, 2011

(30) Foreign Application Priority Data
Nov. 21, 2008 (JP) 2008-298242

(51) Int. Cl. G06F 12/08

(52) U.S. Cl. 711/145; 711/E12.052

(57) ABSTRACT

Solved is a problem that use efficiency of a memory cache is low because in contents distribution using a memory cache whose capacity is limited, even when only a part of contents is accessed, the entire contents will be stored in the memory cache.

The contents distribution device includes a contents holding unit 102 which stores contents to be distributed, a cache holding unit 103 which temporarily stores the contents to be distributed, a contents distribution unit 100 which distributes contents stored in the cache holding unit or the contents holding unit, and a cache control unit 101 which controls storage and deletion of contents in and from the cache holding unit, in which the cache control unit 101 sections the contents into a plurality of blocks and controls storage and deletion in and from the cache holding unit on a block basis based on cache control information which sets a deletion waiting time before deletion from the cache holding unit on a block basis.

### TECHNICAL FIELD

The present invention relates to a system which distributes contents such as video and, more particularly, a contents distribution device, a contents distribution control method and a contents distribution control program which enable distribution performance to be improved by temporarily holding contents in a cache memory and reading and distributing the contents from the cache memory.

### BACKGROUND ART

In a contents distribution system which distributes video contents such as pictures and dramas, used is a cache technique which improves distribution performance by preserving contents on a cache memory and distributing the contents from the cache memory, thereby reducing the number of times of accesses to a disk device which accumulates contents. In contents distribution using a cache memory, since a capacity of a cache memory which caches contents is small as compared with that of a disk device, effective use of a cache region is required.

One example of a method of efficiently using a cache region is disclosed in Patent Literature 1 and Patent Literature 2. With the method recited in Patent Literature 1, when deleting contents from a cache memory, improvement of use efficiency of a cache region is realized by using an expiration date of contents and a contents size to replace contents data.

With the method recited in Patent Literature 2, improvement in use efficiency of a cache region is realized by storing the contents as a plurality of divisional blocks in a cache memory and sequentially deleting the blocks from the cache memory starting with a block whose latest access time is the oldest.
Patent Literature 1: Japanese Patent Laying-Open No. 2003-271442.
Patent Literature 2: Japanese Patent Laying-Open No. 2006-172296.

Related art recited in the above-described Patent Literature 1 and Patent Literature 2, however, have the following problems.

The method of deleting contents from a cache memory by using an expiration date of contents which is recited in Patent Literature 1 has the following problems.

When contents A stored in a cache memory are accessed as shown in FIG. 21, for example, the contents A will be continuously stored in the cache memory. Accordingly, when only a part of the contents A is accessed, although a large part of cache data of the contents A is unnecessary, many regions of the cache memory will be used, so that use efficiency of a cache region will be deteriorated. Deterioration of the use efficiency will have larger effect as the size of contents becomes larger.

In a case where contents stored in a cache are divided into a plurality of blocks and deleted from the cache in order to improve use efficiency of the cache as recited in Patent Literature 2, when an access occurs immediately after deletion, a cache hit rate will be reduced.

The reason is that at the deletion of contents from a cache region, those whose latest access time is the oldest are targeted for deletion.

### OBJECT OF THE INVENTION

An object of the present invention is to provide a contents distribution device, a contents distribution control method and a contents distribution control program which enables use efficiency of a cache region to be improved in contents distribution using a cache memory.

### SUMMARY

According to a first exemplary aspect of the invention, a contents distribution device, includes a contents holding unit which stores contents to be distributed, a cache holding unit which temporarily stores the contents to be distributed, a contents distribution unit which distributes the contents stored in the cache holding unit or the contents holding unit, and a cache control unit which controls storage and deletion of contents in and from the cache holding unit, wherein the cache control unit sections the contents into a plurality of blocks and controls storage and deletion in and from the cache holding unit on a block basis based on cache control information which sets a deletion waiting time before deletion from the cache holding unit on the block basis.

According to a second exemplary aspect of the invention, a contents distribution control method in a contents distribution device which distributes contents, includes distributing the contents from a contents holding unit which stores the contents or a cache holding unit which temporarily holds the contents, and sectioning the contents into a plurality of blocks and controlling storage and deletion in and from the cache holding unit on a block basis based on cache control information which sets a deletion waiting time before deletion from the cache holding unit on the block basis.

According to a third exemplary aspect of the invention, a contents distribution control program operable on a computer forming a contents distribution device which distributes contents, which causes the contents distribution device to execute

processing of distributing the contents from a contents holding unit which stores the contents or a cache holding unit which temporarily holds the contents, and processing of sectioning the contents into a plurality of blocks and controlling storage and deletion in and from the cache holding unit on a block basis based on cache control information which sets a deletion waiting time before deletion from the cache holding unit on the block basis.

According to the present invention, it is possible to improve a use efficiency of a cache region in contents distribution using a cache holding unit which caches contents.

### BRIEF DESCRIPTION OF THE DRAWINGS

FIG. 1 is a diagram showing an example of a structure of a contents distribution system according to a first exemplary embodiment of the present invention;

FIG. 2 is a diagram showing one example of a cache control table according to the first exemplary embodiment;

FIG. 3 is a flow chart showing contents registration processing according to the first exemplary embodiment of the present invention;

FIG. 4 is a sequence diagram showing a flow of processing from contents distribution requesting to contents distribution according to the first exemplary embodiment of the present invention;

FIG. 5 is a flow chart showing contents distribution processing according to the first exemplary embodiment of the present invention;

FIG. 6 is a flow chart showing cache storage processing according to the first exemplary embodiment of the present invention;

FIG. 7 is a flow chart showing cache deletion processing according to the first exemplary embodiment of the present invention;

FIG. 8 is a diagram showing one example of the cache control table at the time of generation according to the first exemplary embodiment of the present invention;

FIG. 9 is a diagram showing one example of the cache control table after operation according to the first exemplary embodiment of the present invention;

FIG. 10 is a diagram showing one example of the cache control table at the time of cache storage according to the first exemplary embodiment of the present invention;

FIG. 11 is a diagram showing one example of a cache control table according to a second exemplary embodiment of the present invention;

FIG. 12 is a diagram showing one example of the cache control table after operation according to the second exemplary embodiment of the present invention;

FIG. 13 is a diagram showing one example of a cache control table according to a third exemplary embodiment of the present invention;

FIG. 14 is a diagram showing one example of the cache control table after operation according to the third exemplary embodiment of the present invention;

FIG. 15 is a diagram showing another example of the cache control table according to the third exemplary embodiment of the present invention;

FIG. 16 is a diagram showing one example of a cache control table according to a fourth exemplary embodiment of the present invention;

FIG. 17 is a diagram showing one example of the cache control table after operation according to the fourth exemplary embodiment of the present invention;

FIG. 18 is a diagram showing one example of a cache control table according to a fifth exemplary embodiment of the present invention;

FIG. 19 is a diagram showing one example of the cache control table after operation according to the fifth exemplary embodiment of the present invention;

FIG. 20 is a block diagram showing a hardware structure of the contents distribution device according to the present exemplary embodiment of the present invention; and

FIG. 21 is a diagram showing a problem in related art.

### EXEMPLARY EMBODIMENT

Next, exemplary embodiments of the present invention will be described in detail with reference to the drawings.

### First Exemplary Embodiment

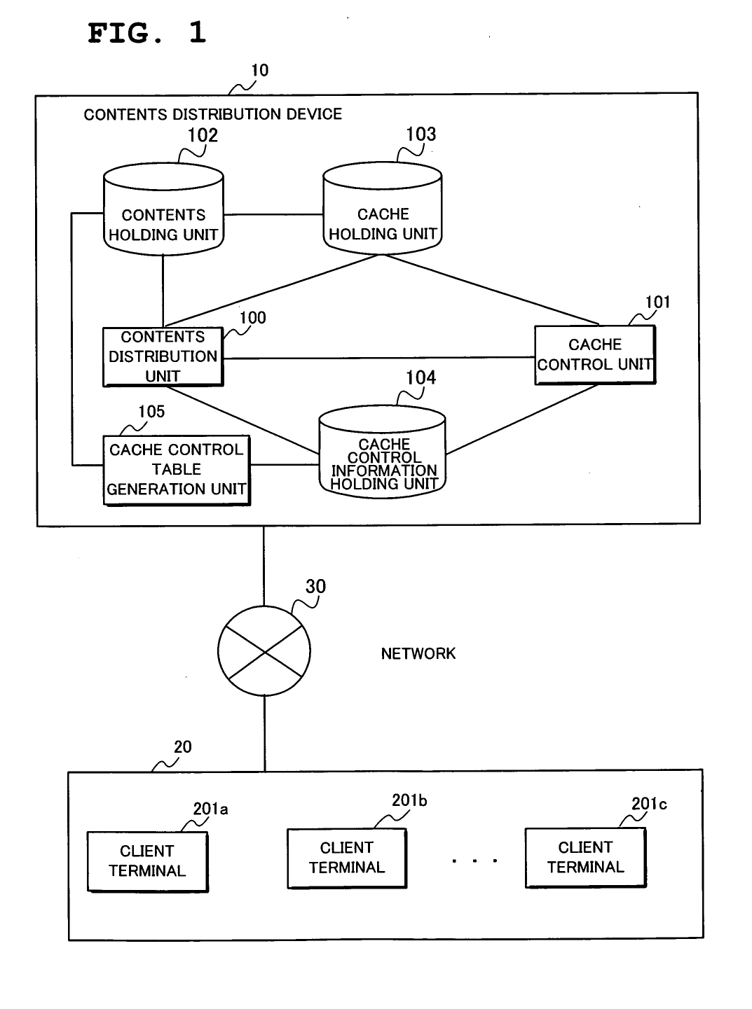

With reference to FIG. 1, a contents distribution system according to a first exemplary embodiment of the present invention includes a contents distribution device 10, a client group 20 which receives contents, and a network 30.

The contents distribution device 10 has a contents distribution unit 100, a cache control unit 101, a contents holding unit 102, a cache holding unit 103, a cache control information holding unit 104 and a cache control table generation unit 105.

The client group 20, which is a terminal that receives contents, has a function for the connection to the network. Although in the present exemplary embodiment, the client group 20 will be described to have three clients, a client terminal 201a, a client terminal 201b and a client terminal 201c, for convenience' sake, the number of clients is assumed to have no limit.

The network 30 is a network such as Internet that connects the contents distribution device 10 and each of the client terminals 201a through 201c of the client group 20.

Functions of these units will be described.

The contents distribution unit 100 receives a contents distribution request from each of the client terminals 201a through 201c of the client group 20. When contents designated by the contents distribution request are stored in the cache holding unit 103, the contents distribution unit 100 reads the contents from the cache holding unit 103 and distributes the contents to each of the client terminals 201a through 201c of the client group 20 through the network 30.

When the designated contents are not stored in the cache holding unit 103, the contents distribution unit 100 instructs the cache control unit 101 to store the contents in question in the cache holding unit 103, as well as reading the contents from the contents holding unit 102 and distributing the same to each of the client terminals 201a through 201c of the client group 20 through the network 30.

According to setting of a cache control table stored in the cache control information holding unit 104, the cache control unit 101 stores the contents of the contents holding unit 102 into the cache holding unit 103 by the instruction of the contents distribution unit 100. The cache control unit 101 also deletes a cache of each contents stored in the cache holding unit 103 on a block basis according to a state of access to a block of contents or a cache deletion timer time set in the cache control table stored in the cache control information holding unit 104.

The contents holding unit 102, which is a unit that stores distributable contents, is realized, for example, by a hard disk device formed of a non-volatile memory such as a magnetic disk or a semiconductor memory. Contents to be stored in the contents holding unit 102 are video contents such as picture or drama or the like, which may be other kinds of contents without necessarily limiting to video contents.

The cache holding unit 103, which has a function as a cache memory for temporarily storing contents, holds distributable contents as a plurality of divisional blocks on a region. The cache holding unit 103 is realized by a RAM (Random Access Memory) or the like.

The cache control table generation unit 105 generates a cache control table 200 on a contents basis as information which controls a cache held in the cache holding unit 103.

The cache control information holding unit 104 holds the cache control table 200 generated on a contents basis by the cache control table generation unit 105.

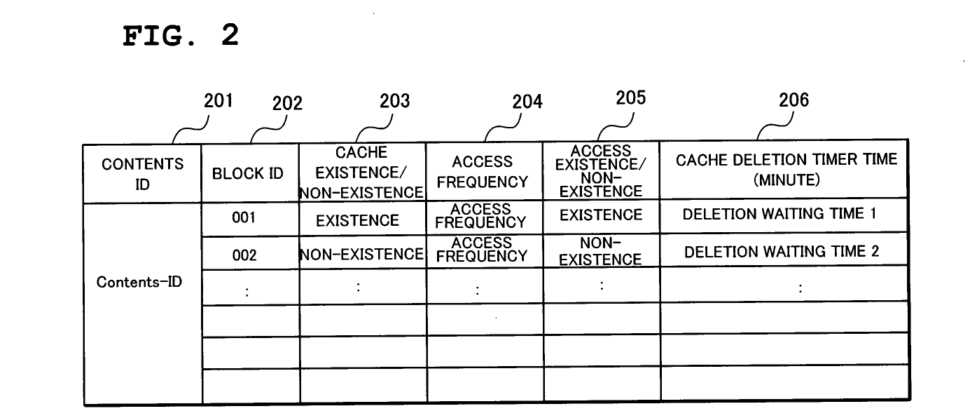

FIG. 2 shows one example of the cache control table. In this example, the cache control table 200 is formed of a contents ID 201, a block ID 202, a cache existence/non-existence 203, an access frequency 204, an access existence/non-existence 205 and a cache deletion timer time 206.

The contents ID 201 here is an ID to be applied on a contents basis. The block ID 202 is an ID, when one content is divided into a plurality of blocks, which is to be applied to each block, and for each bock ID 202, cache control information is set. The cache existence/non-existence 203 is information indicating whether a block of a content corresponding to the block ID 202 in question is already stored in the cache holding unit 103. The access frequency 204 is information indicative of an access frequency corresponding to a block indicated by the block ID 202 in question, in which the number of accesses according to an access to the block in question or the degree corresponding to the number of accesses is set. The access existence/non-existence 205 is information indicating whether a cache of the block ID 202 in question is being accessed or not. The cache deletion timer time 206 is information indicative of a waiting time until data deletion when no access is executed to the block in question for more than a fixed time period.

The cache control table 200 is generated by the cache control table generation unit 105 and registered in the cache control information holding unit 104 as cache control information when registering contents at the contents distribution device 10, that is, in the processing of storing the contents in the contents holding unit 102, and is appropriately updated as required.

The cache control table generation unit 105 generates the above-described cache control table 200 based on a rule set in advance (e.g. a rule which sets sectioning of contents on a fixed size or time basis) and registers the same in the cache control information holding unit 104 when the processing of storing contents in the contents holding unit 102 is executed.

It is also possible to generate the cache control table 200 related to contents to be stored and register the same in the cache control information holding unit 104 by a manager when storing the contents in the contents holding unit 102. When the manager thus generates the cache control table 200, the cache control table generation unit 105 may be omitted.

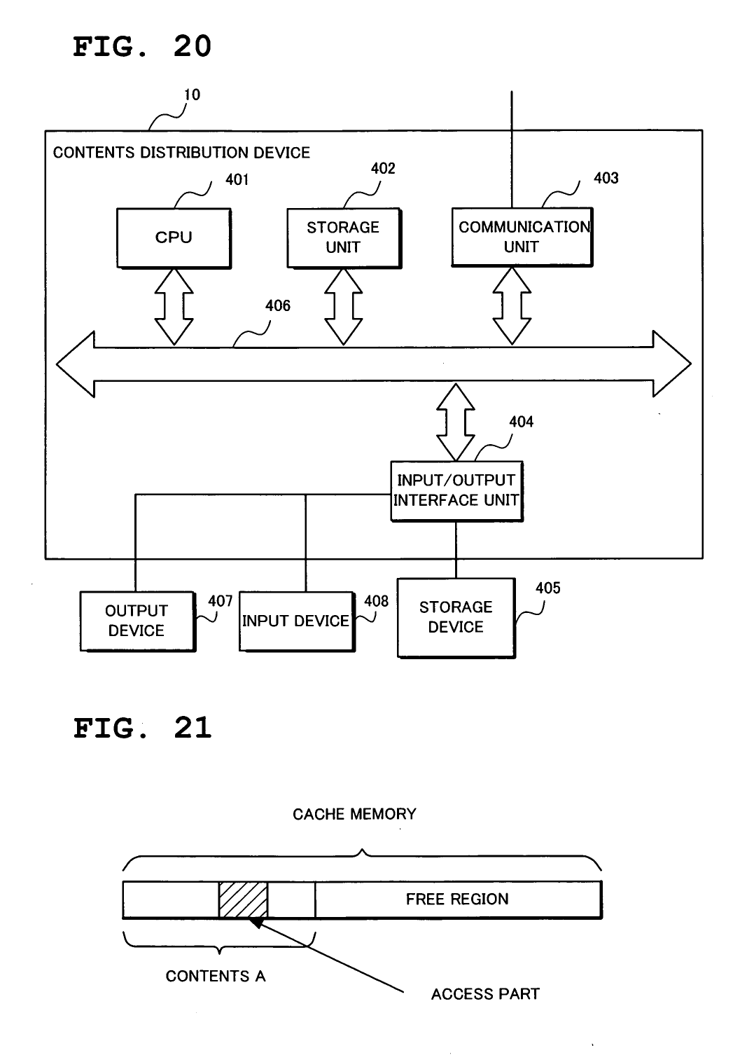

FIG. 20 is a block diagram showing a hardware structure of the contents distribution device 10.

With reference to FIG. 20, the contents distribution device 10, which can be realized by the same hardware structure as a common computer device, comprises a CPU (Central Processing Unit) 401, a storage unit 402 (forming the cache holding unit 103) for use as a data working region or a data temporary saving region which is formed of an RAM (Random Access Memory) or the like, a communication unit 403 which transmits and receives data through the network 30, an input/output interface unit 404 which connects to an external device to transmit and receive data, a subsidiary storage unit 405 (forming the contents holding unit 102 and the cache control information holding unit 104) which is a hard disk device formed of a non-volatile memory such as a ROM (Read Only Memory), a magnetic disk and a semiconductor memory, a system bus 406 which connects the above-described respective components with each other, an output device 407 such as a display device, and an input device 408 such as a keyboard. The contents distribution device 10 according to the present exemplary embodiment has its operation realized not only in hardware by mounting a circuit part which is a hardware part such as an LSI (Large Scale Integration) with a contents distribution control program incorporated that executes contents distribution processing, cache control processing and cache control table generation processing but also in software by storing a contents distribution control program which provides each function of the above-described contents distribution unit 100, cache control unit 101 and cache control table generation unit 105 into the subsidiary storage unit 405 and loading the program into the storage unit 402 to execute the same by the CPU 401.

### (Operation of the First Exemplary Embodiment)

Next, entire operation of the contents distribution device 10 according to the present exemplary embodiment will be detailed.

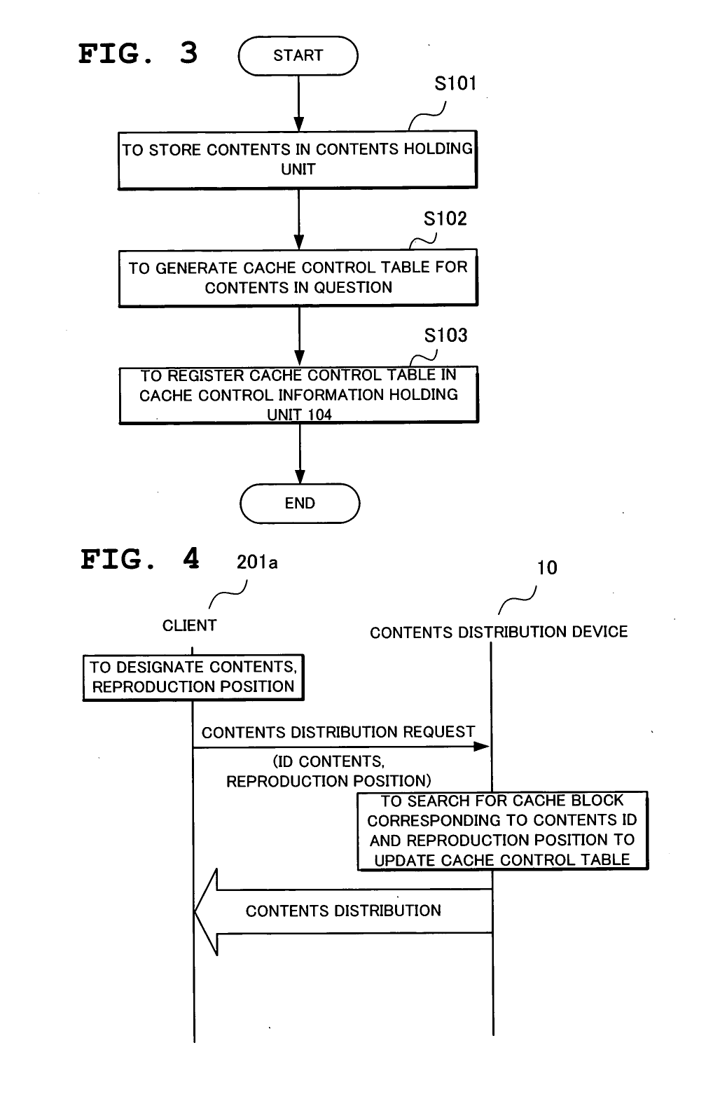

First, description will be made of operation, in the processing of storing contents in the contents holding unit 102, of generating the cache control table 200 to be held by the cache control information holding unit 104 by the cache control table generation unit 105 with reference to the flow chart in FIG. 3.

When contents are stored in the contents holding unit 102 (Step S101), the cache control table generation unit 105 generates the cache control table 200 as to the stored contents (Step S102) and registers the same in the cache control information holding unit 104 (Step S103).

In the generation of the cache control table 200, the cache control table generation unit 105 registers the contents ID 201 which identifies stored contents, based on a predetermined blocking rule, sections the contents into a plurality of blocks and applies the block ID 202 to each block, and registers the cache deletion timer time 206 on a block basis.

The blocking rule indicates, for example, when contents are divided into a plurality of blocks and stored in the cache holding unit 103, how contents should be sectioned (contents sectioning manner) into a plurality of blocks. For example, a data size or a reproduction time of a block is designated as a blocking rule.

In a case of contents (video) coded by a fixed rate, for example, because a data size and a reproduction time unitarily correspond with each other, sectioning the contents by a fixed reproduction time results in making a size of each block be all the same. In a case of contents coded by a variable rate, because a data size and a reproduction time fail to unitarily correspond with each other, sectioning the contents by a fixed reproduction time results in making a size of each block vary according to each rate and sectioning the contents by a fixed size results in making a reproduction time of each block vary according to each rate.

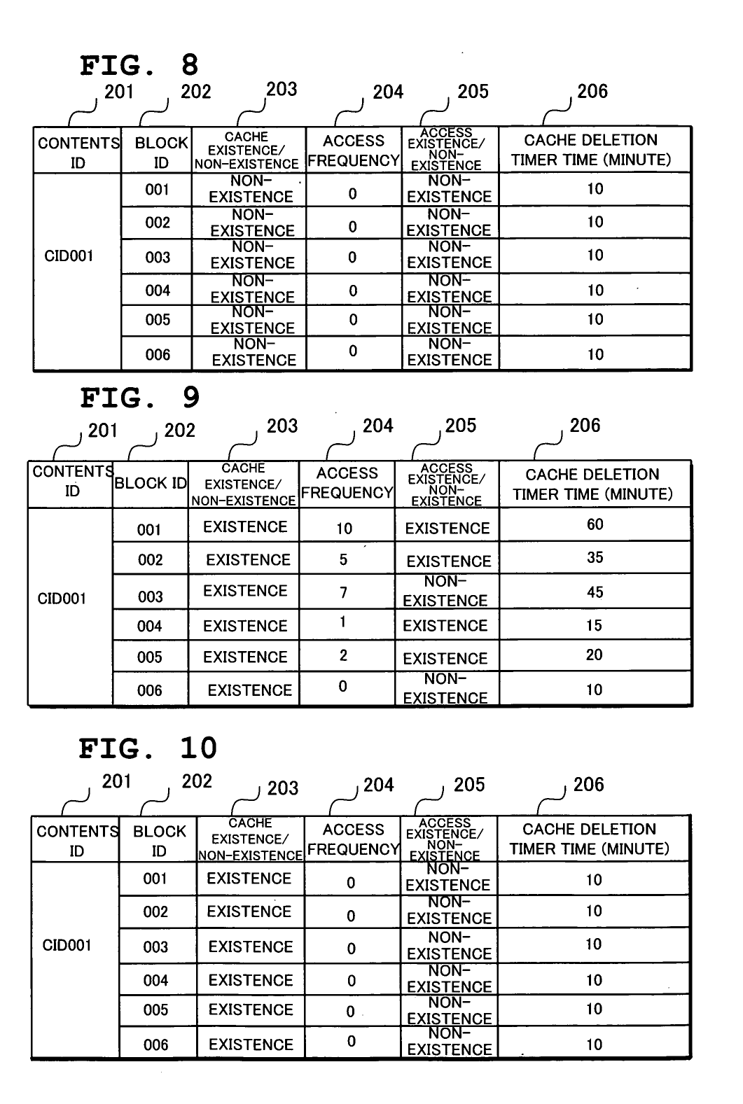

One example of the cache control table 200 will be described with reference to FIG. 8. FIG. 8 shows one example of the cache control table 200 generated immediately after contents registration. The contents are divided into six blocks to have an appropriate size, and to the respective blocks, the block ID 202, the cache existence/non-existence 203, the access frequency 204, the access existence/non-existence 205 and the cache deletion timer time 206 are set, respectively. In this example, because it is immediately after contents registration, the cache existence/non-existence 203 is all set to be “non-existence”, the access frequency 204 to be “0”, the access existence/non-existence 205 to be “non-existence”, and the cache deletion timer time 206 to be “ten minutes” as an initial setting value.

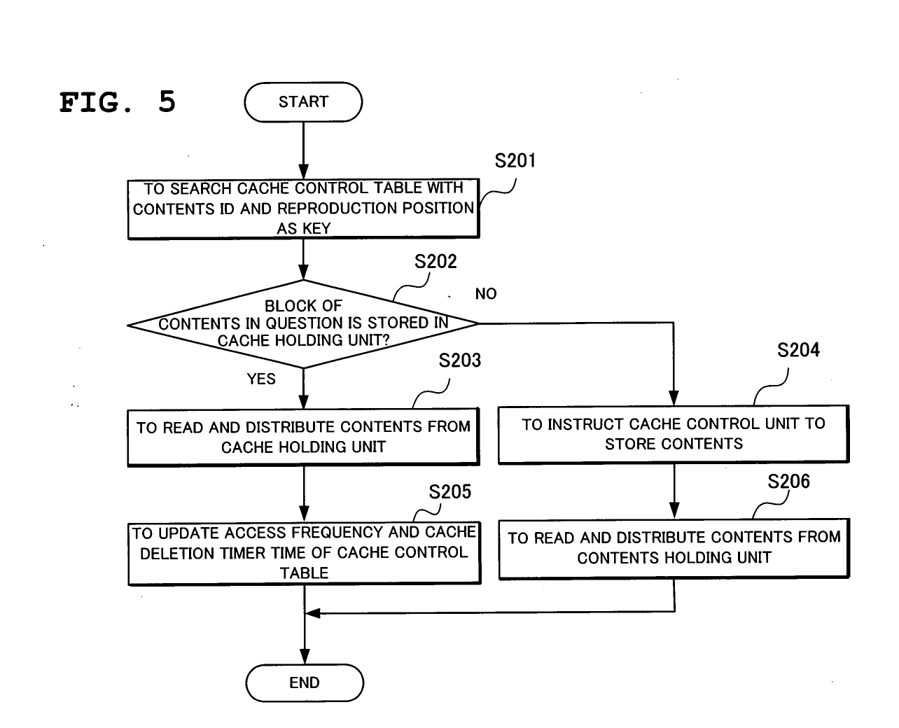

Next, description will be made of operation of starting distribution of contents by the contents distribution device 10 upon receiving a contents distribution request from each of the client terminals 201a through 201c with reference to the sequence diagram of FIG. 4 and the flow chart of FIG. 5.

In the sequence diagram of FIG. 4, the client terminals 201a to 201c designate a reproduction position of contents whose distribution is to be requested and request the contents distribution device 10 to distribute the contents.

The contents distribution device 10 having received the contents distribution request searches the cache control table 200 for a block corresponding to the requested contents and reproduction position, reads the block corresponding to the requested contents reproduction position from the cache holding unit 103 or the contents holding unit 102 and distributes the same to the client terminals 201a through 201c to update the cache control table 200 as required. Reproduction position here is a position, for example, which is designated by a reproduction time from the first of the contents.

Next, detailed description will be made of operation of contents distribution by the contents distribution device 10 with reference to FIG. 5.

Upon receiving a contents distribution request from the client terminals 201a through 201c, the contents distribution unit 100 of the contents distribution device 10 searches the cache control table 200 in the cache control information holding unit 104 with a contents ID whose distribution is designated and a reproduction key as a key (Step S201). Then, the contents distribution unit 100 determines whether a block corresponding to the designated reproduction position of the requested contents is stored in the cache holding unit 103 (Step S202).

When the block of the contents in question is stored in the cache holding unit 103, the contents distribution unit 100 reads data of the contents block in question from the cache holding unit 103 and distributes the same to the client terminals 201a through 201c (Step S203). Thereafter, the contents distribution unit 100 updates the access frequency 204 and the cache deletion timer time 206 of a block belonging to the contents in question in the cache control table 200 in the cache control information holding unit 104 (Step S205).

FIG. 9 shows one example of the cache control table 200. An access frequency is recorded in the access frequency 204 and according to the frequency, the cache deletion timer time 206 is set. In the example shown in FIG. 9, the higher the access frequency becomes, the longer the cache deletion timer time is set to be.

Also in FIG. 9, an updating value of the cache deletion timer time 206 is set to be “five minutes” and the cache deletion timer time 206 is incremented by “five minutes” at every cache access to the cache holding unit 103.

Thus, it is possible to update the cache deletion timer time 206 by addition of a fixed time at every cache access or change an updating value of the cache deletion timer time 206 on a block basis or according to the degree of an access frequency.

With a threshold value set as an access frequency (e.g. ten times), for example, when an access frequency is not more than the threshold value, an updating value is set to be five minutes and when it overs the threshold value, the updating value is set to be ten minutes. Also possible is to provide stages in a threshold value of an access frequency (e.g. a first threshold value is ten times and a second threshold value is 20 times) to set an updating value to be five minutes when it is not more than the first threshold value, ten minutes when it overs the first threshold value and 15 minutes when it overs the second threshold value. Setting stages of the threshold value to be not less than three stages to change an updating value for each threshold value enables further minute cache control.

When no data of a block part of a content in question is stored in the cache holding unit 103, the contents distribution unit 100 instructs the cache control unit 101 to store the data of the block part of the content in question in the cache holding unit 103 (Step S204). The contents distribution unit 100 also reads the data of the block part of the content in question from the contents holding unit 103 and distributes the same to the client terminals 201a through 201c (Step S206).

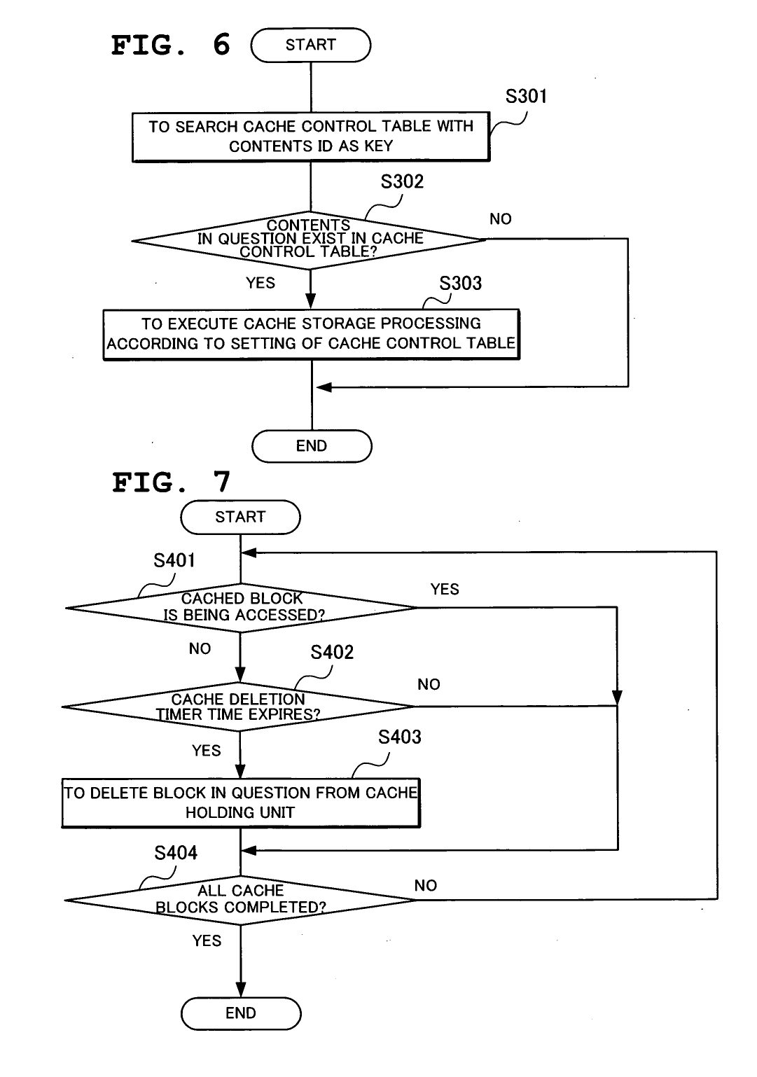

Next, description will be made of operation of storing data of contents in the cache holding unit 103 by the cache control unit 101 based on an instruction from the contents distribution unit 100 with reference to the flow chart in FIG. 6.

Upon receiving a cache storage instruction from the contents distribution unit 100, the cache control unit 101 searches the cache control table 200 held in the cache control information holding unit 104 with designated contents ID and reproduction position as a key (Step S301) to confirm registration of a block corresponding to the reproduction position of the contents in question in the cache control table 200 (Step S302).

When the block corresponding to the reproduction position of the contents in question is registered in the cache control table 200, the cache control unit 101 stores data of the block part of the contents in question into the cache holding unit 103 according to setting of the cache control table 200 to update the cache control table 200 (Step S303). In other words, the cache existence/non-existence 203 of the block in question in the cache control table 200 is set to be “existence”.

FIG. 10 shows one example of the cache control table 200 after being updated. Here, although since data of blocks 001 through 006 of a content (ID:CID001) is registered in the cache holding unit 103, cache existence/non-existence information is all “existence”, the access frequency 204, the access existence/non-existence 205 and the cache deletion timer time 206 are set to be initial values because of no access immediately after storage.

Cache-accessing a block of a content registered in the cache holding unit 103 results in updating a cache deletion timer time set for each block as shown in FIG. 5.

Shown in FIG. 9 is, for example, a state of the cache control table 200 in a case where each block of a content indicated in the cache control table 200 shown in FIG. 10 is cache-accessed. FIG. 9 shows that ten times of cache access is made to the block (ID: 001), five times to a block (ID: 002), seven times to a block (ID: 003), once to a block (ID: 004), twice to a block (ID: 005) and none to a block (ID: 006). As a result, the cache deletion timer time 206 of each block has “five minutes” of an updating value added at every access to update the block (ID: 001) to “60 minutes”, the block (ID: 002) to “35 minutes”, the block (ID: 003) to “45 minutes”, the block (ID: 004) to “15 minutes” and the block (ID: 005) to “20 minutes”. As to the block (ID: 001), the value remains “ten minutes” as the initial value because of no access.

Next, description will be made of operation in processing of deleting cache data of contents stored in the cache holding unit 103 by the cache control unit 101 with reference to the flow chart in FIG. 7.

The cache control unit 101 refers to the access existence/non-existence 205 of the cache control table 200 stored in the cache control information holding unit 104 to check whether a block of contents cached in the cache holding unit 103 is being accessed (Step S401). When the block in question is being accessed, move to Step S404.

When the block in question is not being accessed, the cache control unit 101 next checks whether a timer time set at the cache deletion timer time 206 of the cache control table 200 expires with respect to the block in question (Step S402). When the cache deletion timer time is yet to expire, move to Step S404.

Whether the cache deletion timer time 206 of the cache control table 200 expires or not is determined by comparing an elapsed time from a time point where each block is stored in the cache holding unit 103 or a time point of last cache access with the cache deletion timer time 206 to find whether the elapsed time overs the cache deletion timer time 206.

In a case, for example, of a block never yet to be cache-accessed after its storage in the cache holding unit 103, compare an elapsed time from a time point of storage in the cache holding unit 103 with the cache deletion timer time 206 and in a case of a cache-accessed block, compare an elapsed time from a time point of last cache access with the cache deletion timer time 206.

When the cache deletion timer time expires, delete cache data corresponding to the block in question from the cache holding unit 103 and set the cache existence/non-existence 203 for a block of a content in question in the cache control table 200 to be “non-existence” (Step S403).

In a case of the block in question being accessed at Step S401, when the cache deletion waiting timer time 206 is yet to expire at Step S402 or when the processing at Step S403 ends, determine whether processing of all the blocks in the cache control table 200 is completed or not (Step S404) and when it is yet to be completed, execute processing of Steps S401 through S403.

The cache control unit 101 executes the above-described series of processing (from Step S401 to Step S403) with respect to all the contents registered at the cache control table 200 and ends the processing.

The above-described processing by the cache control unit 101 is cyclically executed at time intervals, for example, of every one minute, to update cache data in the cache control table 200 and the cache holding unit 103.

In one example of the cache control table 200 shown in FIG. 9, the contents are stored as divisional six blocks. The block ID006 is yet to be accessed and if it remains in a no-access state, when the time “12 minutes” set at the cache deletion timer expires, the cache data of the block ID006 will be deleted from the cache holding unit 103.

### (Effects of the First Exemplary Embodiment)

Next, effects of the first exemplary embodiment will be described.

According to the first exemplary embodiment, since contents on the cache holding unit 103 are divided into a plurality of blocks to record the statistics of an access frequency on a block basis and update a cache deletion timer time which is a time before block deletion according to the access frequency, cache control is realized according to real-time popularity of contents. Thus, holding contents whose access frequency is high longer in a cache and deleting those whose access frequency is low earlier from the cache holding unit 103 enables a block whose access frequency is low to be efficiently deleted from a cache.

In other words, the first exemplary embodiment enables an unnecessary block in contents to be deleted from a cache to leave only the least necessary cache data, thereby improving cache use efficiency. As a result, as compared with the related art method, a cache hit rate can be improved to enable effective use of a cache region.

### Second Exemplary Embodiment

Next, a second exemplary embodiment of the present invention will be described. Since structures of a contents distribution system and its contents distribution device 10 according to the second exemplary embodiment are the same as those of the first exemplary embodiment shown in FIG. 1, no description will be made thereof.

The second exemplary embodiment is premised on that contents are encoded by a hierarchical coding system. Here, the hierarchical coding system, as an example, is a system whose representative is H.264/SVC defined by ITU-T, and in which contents encoded by H.264/SVC are layered such as a basic layer, an extended layer 1 and an extended layer 2. While in the hierarchical coding system, the higher hierarchy a used layer has, the higher can be reproduced image quality video, video can be reproduced with data of only low hierarchy layers.

In the hierarchical coding system by H.264/SVC, for example, contents coded using up to the highest extended layer 2 can be reproduced in a large screen and with high quality, while contents coded using up to the extended layer 1 can be reproduced in a medium-sized screen and with medium quality. Contents coded using only a basic layer will be reproduced in a smaller-sized screen and with lower quality as compared with those using layers including the extended layers 1 and 2. As to data size of contents, it becomes larger when layers up to the extended layer 2 as a higher layer are included and it becomes smaller when only a basic layer as a lower layer is included.

Difference from the first exemplary embodiment is that contents are sectioned according to not a size or a reproduction time but coding hierarchy and the present exemplary embodiment makes use of this characteristic to section a block on a coding layer basis at the time of cache storage and set a cache deletion timer time to be shorter as a block layer becomes higher.

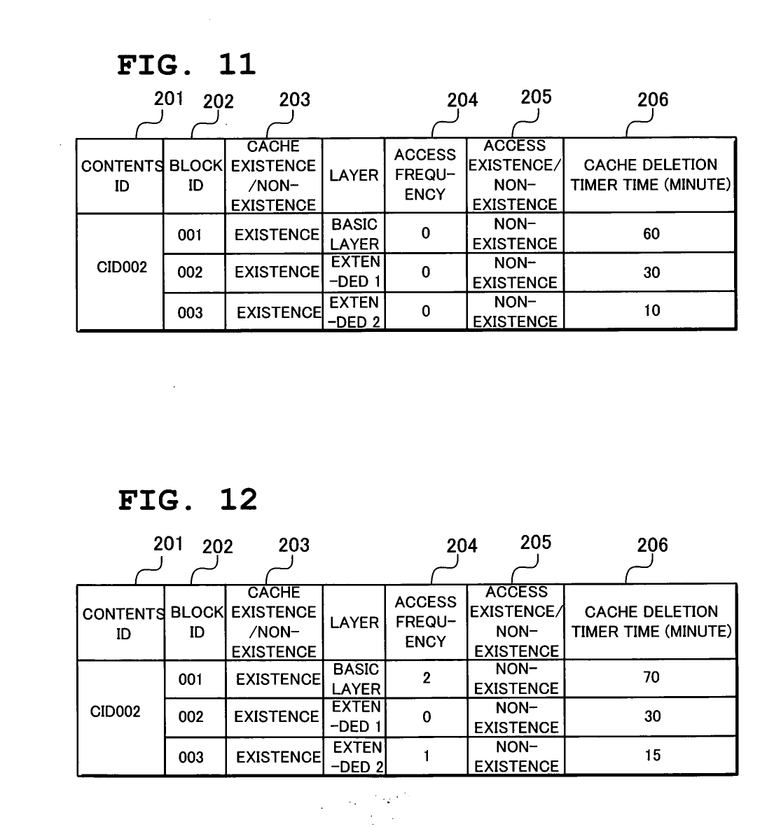

FIG. 11 shows an example of the cache control table 200 generated by the cache control table generation unit 105 in the second exemplary embodiment.

In the example shown in FIG. 11, contents are formed to have three layers, a basic layer (lower layer), an extended layer 1 (medium layer) and an extended layer 2 (higher layer), with the basic layer set to have “60 minutes” as the cache deletion timer time 206, the extended layer 1 “30 minutes” and the extended layer 2 “10 minutes”, in which the higher the layer becomes, the shorter is the cache deletion timer time 206. FIG. 11 also shows contents in a state where no access is made immediately after registration to the cache holding unit 103, in which cache existence/non-existence information is all “existence” and the access frequency 204, the access existence/non-existence 205 and the cache deletion timer time 206 are set to be their initial values.

In a case, for example, where the cache deletion timer time 206 is updated by the addition of “five minutes” each every time a cache-access is made to the cache holding unit 103, when two cache accesses are made to the block (ID: 001) of the basic layer and one cache-access is made to the block (ID: 003) of the extended layer 2, the cache deletion timer times 206 of the block (ID: 001) and the block (ID: 003) of the cache control table 200 shown in FIG. 11 will be updated to “70 minutes” and “15 minutes”, respectively, as shown in FIG. 12. As to the block (ID: 002), its value remains the initial value of “30 minutes” because of no access.

In the second exemplary embodiment, the contents are sectioned into blocks on a layer basis to generate the cache control table 200 and since the remaining contents storage processing, contents distribution processing, cache storage processing and cache deletion processing are the same as those of the first exemplary embodiment, no description will be made thereof.

Also in this exemplary embodiment, the cache deletion timer time 206 is updated every time the cache holding unit 103 is accessed on a basis of a block of each layer. In this case, it is also possible to set an updating value which varies with a layer of each block. Updating value is set such as “10 minutes” for the basic layer, “five minutes” for the extended layer 1 and “three minutes” for the extended layer 2, for example. Thus changing an updating value on a layer basis enables a block of a layer whose data size is larger and whose access frequency seems to be lower to be deleted from the cache holding unit 103 earlier, thereby improving cache use efficiency.

Also possible, similarly to the first exemplary embodiment, is to set a threshold value for an access frequency and change an updating value based on the threshold value or change an amount of change of an updating value on a layer basis.

While the foregoing description has been made of a case where contents coding layers are three, it is apparent that the same method as described above is applicable also to contents coded by more layers.

### (Effects of the Second Exemplary Embodiment)

Similarly to the first exemplary embodiment, the second exemplary embodiment enables the amount of cache data to be gradually reduced while maintaining a cache hit rate at the time of deleting a block whose cache deletion timer time elapses from the cache holding unit 103 after no access remains. As well as improvement of a cache hit rate, improvement of cache memory use efficiency can be realized.

In addition, since in the second exemplary embodiment, contents are sectioned into a plurality of blocks according to a coding layer, it is possible to leave a block of a layer whose access frequency is high and whose data size is small longer in the cache and delete a block of a layer whose access frequency is low and whose data size is large earlier from the cache, thereby further improving use efficiency of a cache memory.

### Third Exemplary Embodiment

Next, a third exemplary embodiment of the present invention will be described. Since structures of a contents distribution system and its contents distribution device 10 according to the third exemplary embodiment are the same as those of the first exemplary embodiment shown in FIG. 1, no description will be made thereof.

The third exemplary embodiment is structured to section contents into a plurality of blocks according to coding hierarchy (layer) similarly to the above-described second exemplary embodiment, as well as further sectioning the same into a plurality of blocks of each layer, thereby further improving use efficiency of a cache memory.

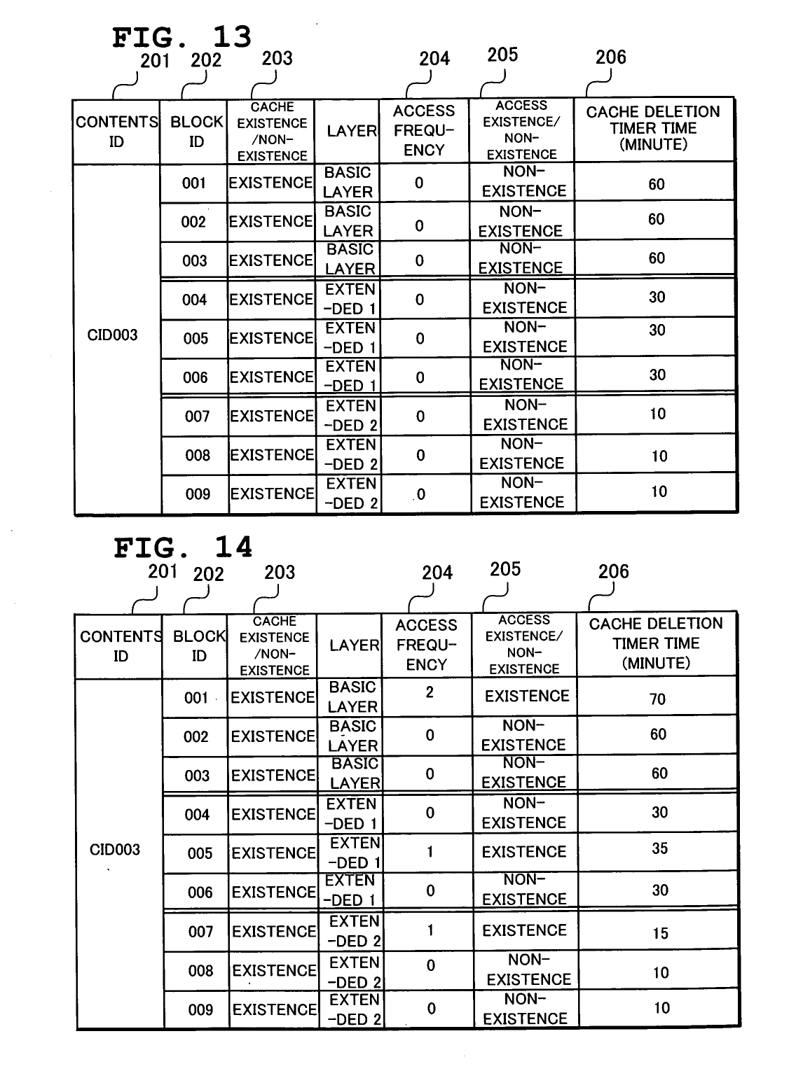

FIG. 13 shows one example of the cache control table 200 generated by the cache control table generation unit 105 according to the third exemplary embodiment.

In the example shown in FIG. 13, contents are formed to have three layers and each layer is sectioned into three blocks, to each of which blocks, a cache deletion timer time is set.

When sectioning the contents on a layer basis and further sectioning them into a plurality of blocks, the cache control table generation unit 105 sections them, for example, based on a predetermined blocking rule on a block data size or reproduction time basis as described in the first exemplary embodiment.

In the example of FIG. 13, the contents are formed of three layers, a basic layer (lower layer), an extended layer 1 (medium layer) and an extended layer 2 (higher layer), and each layer is sectioned into three blocks, to each of which blocks a cache deletion timer time is set.

The three blocks of the basic layer have “60 minutes” set as the cache deletion timer time 206, three blocks of the extended layer 1 have “30 minutes” set and the three blocks of the extended layer 2 have “10 minutes” set, in which the higher the layer becomes, the shorter is the cache deletion timer time 206. FIG. 13 also shows contents of a state where no access is made immediately after registration to the cache holding unit 103, in which cache existence/non-existence information is all “existence” and the access frequency 204, the access existence/non-existence 205 and the cache deletion timer time 206 are set to be their initial values.

In a case, for example, where it is set that the cache deletion timer time 206 is updated by the addition of “five minutes” each every time the cache holding unit 103 is accessed, when two accesses are made to the block (ID: 001) of the basic layer and one access each is made to the block (ID: 005) of the extended layer 1 and the block (ID: 007) of the extended layer 2, the cache deletion timer time 206 of the block (ID: 001), the block (ID: 005) and the block (ID: 007) in the cache control table 200 shown in FIG. 13 will be updated to “70 minutes”, “35 minutes” and “15 minutes”, respectively, as shown in FIG. 14.

In the third exemplary embodiment, the cache control table 200 is generated in which the contents are sectioned into blocks on a layer basis and a block of each layer is further sectioned into a plurality of blocks on a predetermined data size or predetermined reproduction time basis, and since the remaining contents storage processing, contents distribution processing, cache storage processing and cache deletion processing are the same as those of the first exemplary embodiment, no description will be made thereof.

Also according to the third exemplary embodiment, the cache deletion timer time 206 may be updated by increment by a fixed time at every cache access or an updating value of the cache deletion timer time 206 can be changed on a block basis or according to an access frequency.

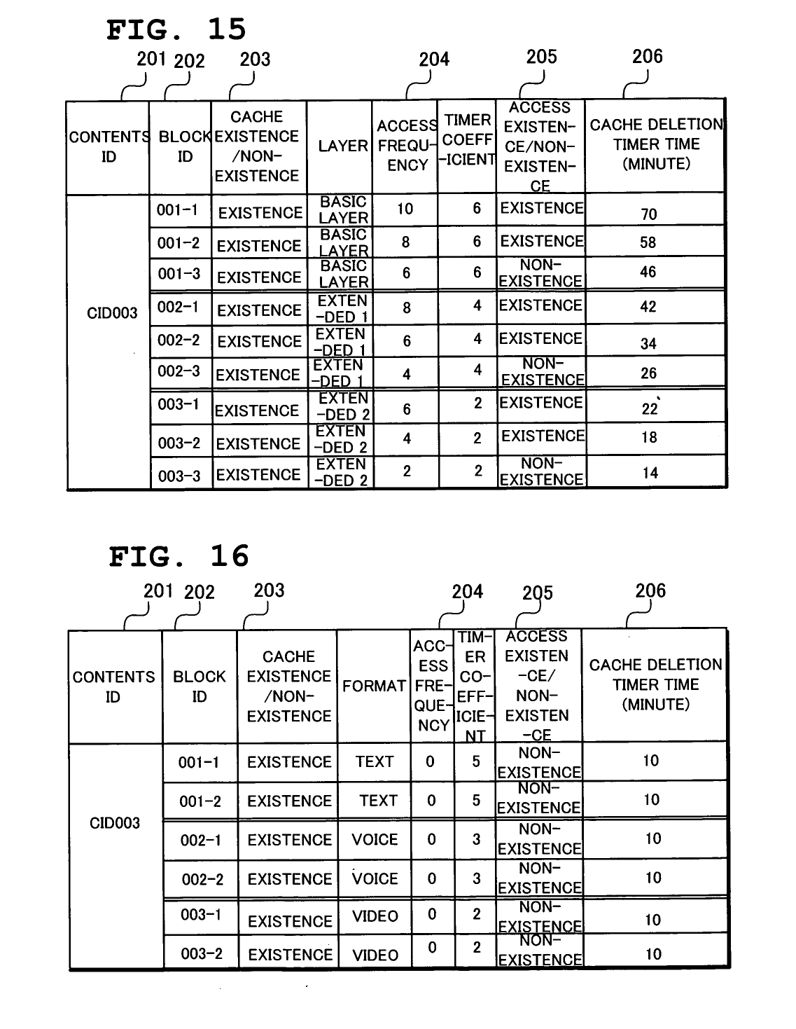

Shown in the example of the cache control table 200 in FIG. 15 is an example in which a timer coefficient indicative of an updating value of the cache deletion timer time 206 is set to be a different value for each layer. An initial value of the cache deletion timer time 206 in this case is assumed to be “ten minutes” in each block.

In the example in FIG. 15, a timer coefficient is set such that the lower a layer becomes which is expected to have more accesses, the longer is the cache deletion timer time 206. For example, with the timer coefficient of “6” set for the basic layer, “4” set for the extended layer 1 and “2” set for the extended layer 2, at every cache access to a block of a layer in question, six minutes, four minutes and two minutes will be added to the cache deletion timer time 206, respectively. This realizes control such that a lower layer expected to have more accesses will remain longer in the cache holding unit 103.

In addition, similarly to the first exemplary embodiment, it is possible to provide a threshold value for an access frequency of each block to change an updating value based on the threshold value or change the amount of change of an updating value on a layer basis.

While the foregoing description has been made of a case where contents have three coding layers, it is apparent that the same method as that described above is applicable also to contents coded in more layers. Moreover, while shown is an example where each layer is divided into three blocks, the number of blocks may vary with each layer according an expected number of accesses. For example, the number of blocks of a layer (basic layer) whose number of accesses is large may be set to be larger than other layers (extended layers 1 and 2). This enables use efficiency of a cache memory to be improved.

### (Effects of the Third Exemplary Embodiment)

Since each layer is further divided into a plurality of blocks to execute control, the third exemplary embodiment enables a cache hit rate to be further improved than the second exemplary embodiment to further increase use efficiency of a cache memory.

### Fourth Exemplary Embodiment

Next, a fourth exemplary embodiment of the present invention will be described. Since structures of a contents distribution system and its contents distribution device 10 according to the fourth exemplary embodiment are the same as those of the first exemplary embodiment shown in FIG. 1, no description will be made thereof.

The fourth exemplary embodiment differs from the above-described exemplary embodiments in that contents are sectioned into a plurality of blocks according to a format of data included in the contents.

FIG. 16 shows one example of the cache control table 200 generated by the cache control table generation unit 105 according to the fourth exemplary embodiment.

As shown in FIG. 16, out of data included in contents, a text format part, a voice format part and a video format part are sectioned into two blocks each in the fourth exemplary embodiment.

Furthermore, by setting an updating value of data (e.g. text) which is expected to have more accesses such that the cache deletion timer time 206 is longer, control is executed such that data expected to have more accesses will remain longer in the cache holding unit 103.

FIG. 16 shows the cache control table 200 in an initial state where contents are stored in the cache holding unit 103, in which the access frequency 204 and the cache deletion timer time 206 of each block are set to be their initial values. In addition, at each block, a timer coefficient indicative of an updating value of the cache deletion timer time 206 is set. Set in this example are “5” as the timer coefficient of a block corresponding to a text format, and “3” and “2” as the timer coefficients of blocks corresponding to voice and video formats, respectively.

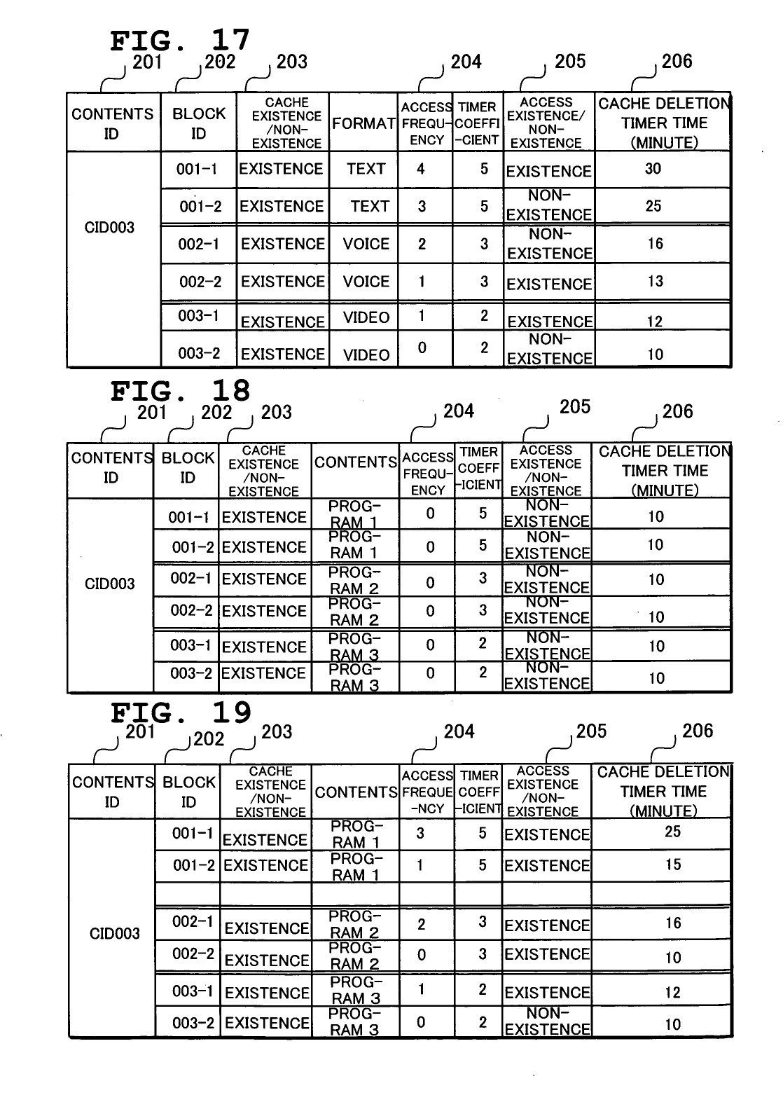

FIG. 17 shows a state of the cache control table 200 when four times of cache accesses are made to the block (ID: 001-1) of a text, three times to the block (ID: 001-2), twice to a voice block (ID: 002-1), once to a block (ID: 002-2) and once to a video block (ID: 003-1). Here, since timer coefficients are “five minutes”, “three minutes” and “two minutes” for text, voice and video, respectively, the cache deletion timer time 206 of each block is updated as shown in the figure. Since as to a video block (ID: 003-2), no cache access is yet to be made, the cache deletion timer time 206 remains “ten minutes” as the initial value.

### (Effects of the Fourth Exemplary Embodiment)

According to the fourth exemplary embodiment, since contents are sectioned into a plurality of blocks according to a format of data included in the contents to execute cache control on a block basis, it is possible to leave a block of data whose access frequency is high for a longer period of time in a cache and delete a block of data whose access frequency is low earlier from the cache, thereby improving use efficiency of a cache memory.

### Fifth Exemplary Embodiment

Next, a fifth exemplary embodiment of the present invention will be described. Since structures of a contents distribution system and its contents distribution device 10 according to the fifth exemplary embodiment are the same as those of the first exemplary embodiment shown in FIG. 1, no description will be made thereof.

The fifth exemplary embodiment differs from the above-described exemplary embodiments in that contents are sectioned into a plurality of blocks according to items included in the contents such as a program (program items).

FIG. 18 shows one example of the cache control table 200 generated by the cache control table generation unit 105 in the fifth exemplary embodiment.

As shown in FIG. 18, a program 1, a program 2 and a program 3 as program items included in contents are sectioned into two blocks each in the fifth exemplary embodiment.

By setting an updating value of a program which is expected to have more accesses (program whose audience rating is high) such that the cache deletion timer time 206 is longer, control is executed such that a program expected to have more accesses will remain longer in the cache holding unit 103.

FIG. 18 shows the cache control table 200 in an initial state where contents are stored in the cache holding unit 103, in which the access frequency 204 and the cache deletion timer time 206 of each block are set to be their initial values. In addition, at each block, a timer coefficient indicative of an updating value of the cache deletion timer time 206 is set. Set in this example are “5” as the timer coefficient of a block corresponding to the program 1, and “3” and “2” as the timer coefficients of blocks corresponding to the program 2 and the program 3, respectively.

FIG. 19 shows a state of the cache control table 200 when three times of cache accesses are made to the block (ID: 001-1) of the program 1, once to the block (ID: 001-2), twice to the voice block (ID: 002-1) and once to the video block (ID: 003-1). Here, since timer coefficients are “five minutes”, “three minutes” and “two minutes” for text, voice and video, respectively, the cache deletion timer time 206 of each block is updated as shown in the figure. Since as to the voice block (ID: 003-2) and the video block (ID: 003-2), no cache access is yet to be made, the cache deletion timer time 206 remains “ten minutes” as the initial value.

### (Effects of the Fifth Exemplary Embodiment)

According to the fifth exemplary embodiment, since contents are sectioned into a plurality of blocks on a basis of an item such as a program included in contents to execute cache control on a block basis, it is possible to leave a block of a program whose access frequency is high for a longer period of time in a cache and delete a block of a program whose access frequency is low earlier from the cache, thereby improving use efficiency of a cache memory.

Although the present invention has been described with respect to the preferred modes of implementation and exemplary embodiments in the foregoing, the present invention is not necessarily limited to the above-described modes of implementation and exemplary embodiments but can be modified without departing from the scope of its technical idea.

### Incorporation by Reference

This application is based upon and claims the benefit of priority from Japanese patent application No. 2008-298242, filed on Nov. 21, 2008, the disclosure of which is incorporated herein in its entirety by reference.

### Industrial Applicability

The present invention is applicable to such use as distribution of video contents including broadcasting programs and pictures through a network. It is applicable to a contents distribution system for distributing popular contents which has a large number of subscribers and which is demanded to have high distribution performance, in particular. Contents are applicable, not limited to video, to contents distribution services of various kinds such as music and games.

1. A contents distribution device, comprising:
a contents holding unit which stores contents to be distributed;
a cache holding unit which temporarily stores said contents to be distributed;
a contents distribution unit which distributes said contents stored in said cache holding unit or said contents holding unit; and
a cache control unit which controls storage and deletion of contents in and from said cache holding unit, wherein
said cache control unit sections said contents into a plurality of blocks and controls storage and deletion in and from said cache holding unit on a block basis based on cache control information which sets a deletion waiting time before deletion from said cache holding unit on said block basis.

2. The contents distribution device according to claim 1, wherein said cache control unit determines whether said deletion waiting time has elapsed from a time point of storage in said cache holding unit or a time point of last access to said block based on existence/non-existence of an access to said block stored in said cache holding unit and when said deletion waiting time has elapsed, deletes said block from said cache holding unit.

3. The contents distribution device according to claim 1, wherein said cache control unit updates said deletion waiting time of said cache control information by adding an updating time set in advance to the waiting time according to a frequency of access to said block stored in said cache holding unit.

4. The contents distribution device according to claim 3, wherein at least one threshold value is provided for said access frequency to change a length of said updating time when said access frequency is not more than said threshold value and when the frequency is more than said threshold value.

5. The contents distribution device according to claim 1, wherein said cache control unit determines whether said block stored in said cache holding unit is being accessed or not and when the block is not being accessed, determines whether said deletion waiting time has elapsed related to said block to execute deletion of said block from said cache holding unit.

6. The contents distribution device according to claim 1, wherein said contents are sectioned into a plurality of blocks based on a predetermined data size or reproduction time.

7. The contents distribution device according to claim 1, wherein said contents are sectioned into a plurality of blocks on a basis of a layer of contents encoded by a hierarchical coding system to set said deletion waiting time according to hierarchy of said layer.

8. The contents distribution device according to claim 7, wherein said block on said contents layer basis is further sectioned into a plurality of small blocks to set said deletion waiting time of said small block according to a layer to which said small block belongs.

9. The contents distribution device according to claim 8, wherein the number of said small blocks is changed on said contents layer basis according to an expected access frequency.

10. The contents distribution device according to claim 7, wherein the length of said updating time is changed on said contents layer basis.

11. The contents distribution device according to claim 1, wherein said contents are sectioned into a plurality of blocks on a basis of a format of data included in said contents to set said deletion waiting time according to the format of said data.

12. The contents distribution device according to claim 1, wherein said contents are sectioned into a plurality of blocks on a basis of an item of data included in said contents to set said deletion waiting time according to the item of said data.

13. The contents distribution device according to claim 11, wherein said block on a basis of a format of data of said contents or on a basis of an item of the data is further sectioned into a plurality of small blocks to set said deletion waiting time of said small block on a basis of a format or according to an item of data to which said small block belongs.

14. The contents distribution device according to claim 1, further comprising a control information generation unit which generates said cache control information related to said contents when storing said contents in said contents holding unit.

15. The contents distribution device according to claim 1, further comprising a cache control information holding unit which holds said cache control information related to said block of said contents.

16. The contents distribution device according to claim 1, wherein when contents whose distribution is requested fail to exist in said cache holding unit, said contents distribution unit reads contents from said contents holding unit and stores the contents in said cache holding unit, as well as distributing the contents to a distribution requesting source.

17. A contents distribution control method in a contents distribution device which distributes contents, comprising:
distributing said contents from a contents holding unit which stores said contents or a cache holding unit which temporarily holds said contents; and
sectioning said contents into a plurality of blocks and controlling storage and deletion in and from said cache holding unit on a block basis based on cache control information which sets a deletion waiting time before deletion from said cache holding unit on said block basis.

18. The contents distribution control method according to claim 17, wherein determination is made whether said deletion waiting time has elapsed from a time point of storage in said cache holding unit or a time point of last access to said block based on existence/non-existence of an access to said block stored in said cache holding unit to delete said block from said cache holding unit when said deletion waiting time has elapsed.

19. The contents distribution control method according to claim 17, wherein said deletion waiting time of said cache control information is updated by adding an updating time set in advance to the waiting time according to a frequency of access to said block stored in said cache holding unit.

20. The contents distribution control method according to claim 19, wherein at least one threshold value is provided for said access frequency to change a length of said updating time when said access frequency is not more than said threshold value and when the frequency is more than said threshold value.

21. The contents distribution control method according to claim 17, wherein determination is made whether said block stored in said cache holding unit is being accessed or not and when the block is not being accessed, determination is made whether said deletion waiting time has elapsed related to said block to execute deletion of said block from said cache holding unit.

22. The contents distribution control method according to claim 17, wherein said contents are sectioned into a plurality of blocks based on a predetermined data size or reproduction time.

23. The contents distribution control method according to claim 17, wherein said contents are sectioned into a plurality of blocks on a basis of a layer of contents encoded by a hierarchical coding system to set said deletion waiting time according to hierarchy of said layer.

24. The contents distribution control method according to claim 23, wherein said block on said contents layer basis is further sectioned into a plurality of small blocks to set said deletion waiting time of said small block according to a layer to which said small block belongs.

25. The contents distribution control method according to claim 24, wherein the number of said small blocks is changed on said contents layer basis according to an expected access frequency.

26. The contents distribution control method according to claim 23, wherein the length of said updating time is changed on said contents layer basis.

27. The contents distribution control method according to claim 17, wherein said contents are sectioned into a plurality of blocks on a basis of a format of data included in said contents to set said deletion waiting time according to the format of said data.

28. The contents distribution control method according to claim 17, wherein said contents are sectioned into a plurality of blocks on a basis of an item of data included in said contents to set said deletion waiting time according to the item of said data.

29. The contents distribution control method according to claim 27, wherein said block on a basis of a format of data of said contents or on a basis of an item of the data is further sectioned into a plurality of small blocks to set said deletion waiting time of said small block on a basis of a format or according to an item of data to which said small block belongs.

30. The contents distribution control method according to claim 17, wherein said cache control information is generated related to said contents when storing said contents in said contents holding unit.

31. The contents distribution control method according to claim 17, wherein when contents whose distribution is requested fail to exist in said cache holding unit, contents are read from said contents holding unit and stored in said cache holding unit, as well as being distributed to a distribution requesting source.

32. A computer-readable medium storing a contents distribution control program operable on a computer forming a contents distribution device which distributes contents, wherein said contents distribution control program causes said contents distribution device to execute
processing of distributing said contents from a contents holding unit which stores said contents or a cache holding unit which temporarily holds said contents, and
processing of sectioning said contents into a plurality of blocks and controlling storage and deletion in and from said cache holding unit on a block basis based on cache control information which sets a deletion waiting time before deletion from said cache holding unit on said block basis.

33. The computer-readable medium according to claim 32, wherein determination is made whether said deletion waiting time has elapsed from a time point of storage in said cache holding unit or a time point of last access to said block based on existence/non-existence of an access to said block stored in said cache holding unit to delete said block from said cache holding unit when said deletion waiting time has elapsed.

34. The computer-readable medium according to claim 32, wherein said deletion waiting time of said cache control information is updated by adding an updating time set in advance to the waiting time according to a frequency of access to said block stored in said cache holding unit.

35. The computer-readable medium according to claim 34, wherein at least one threshold value is provided for said access frequency to change a length of said updating time when said access frequency is not more than said threshold value and when the frequency is more than said threshold value.

36. The computer-readable medium according to claim 32, wherein determination is made whether said block stored in said cache holding unit is being accessed or not and when the block is not being accessed, determination is made whether said deletion waiting time has elapsed related to said block to execute deletion of said block from said cache holding unit.

37. The computer-readable medium according to claim 32, wherein said contents are sectioned into a plurality of blocks based on a predetermined data size or reproduction time.

38. The computer-readable medium according to claim 32, wherein said contents are sectioned into a plurality of blocks on a basis of a layer of contents encoded by a hierarchical coding system to set said deletion waiting time according to hierarchy of said layer.

39. The computer-readable medium according to claim 38, wherein said block on said contents layer basis is further sectioned into a plurality of small blocks to set said deletion waiting time of said small block according to a layer to which said small block belongs.

40. The computer-readable medium according to claim 39, wherein the number of said small blocks is changed on said contents layer basis according to an expected access frequency.

41. The computer-readable medium according to claim 38, wherein the length of said updating time is changed on said contents layer basis.

42. The computer-readable medium according to claim 32, wherein said contents are sectioned into a plurality of blocks on a basis of a format of data included in said contents to set said deletion waiting time according to the format of said data.

43. The computer-readable medium according to claim 32, wherein said contents are sectioned into a plurality of blocks on a basis of an item of data included in said contents to set said deletion waiting time according to the item of said data.

44. The computer-readable medium according to claim 42, wherein said block on a basis of a format of data of said contents or on a basis of an item of the data is further sectioned into a plurality of small blocks to set said deletion waiting time of said small block on a basis of a format or according to an item of data to which said small block belongs.

45. The computer-readable medium according to claim 32, wherein said cache control information is generated related to said contents when storing said contents in said contents holding unit.

46. The computer-readable medium according to claim 32, wherein when contents whose distribution is requested fail to exist in said cache holding unit, contents are read from said contents holding unit and stored in said cache holding unit, as well as being distributed to a distribution requesting source.

47. A cache control device of a contents distribution device comprising a contents holding unit which stores contents to be distributed, a cache holding unit which temporarily stores said contents to be distributed, and a contents distribution unit which distributes said contents stored in said cache holding unit or said contents holding unit, which
sections said contents into a plurality of blocks to control storage and deletion in and from said cache holding unit on a block basis based on cache control information which sets a deletion waiting time before deletion from said cache holding unit on said block basis.

48. The cache control device according to claim 47, which determines whether said deletion waiting time has elapsed from a time point of storage in said cache holding unit or a time point of last access to said block based on existence/non-existence of an access to said block stored in said cache holding unit and when said deletion waiting time has elapsed, deletes said block from said cache holding unit.

49. The cache control device according to claim 47, which updates said deletion waiting time of said cache control information by adding an updating time set in advance to the waiting time according to a frequency of access to said block stored in said cache holding unit.
